(19) United States
(12) Patent Application Publication
(10) Pub. No.: US 2009/0136414 A1
(43) Pub. Date: May 28, 2009

(54) Method for downhole sulfur removal and recovery

(76) Inventors: Bryan J. Petrinec, Cedar Park, TX (US); David M. Seeger, Austin, TX (US)

Correspondence Address: KLAUBER & JACKSON, 411 HACKENSACK AVENUE, HACKENSACK, NJ, 07601, US

(21) Appl. No.: 12/316,668

(22) Filed: Dec. 15, 2008

Related U.S. Application Data
(63) Continuation-in-part of application No. 11/207,566, filed on Aug. 19, 2005.
(60) Provisional application No. 60/604,510, filed on Aug. 26, 2004.

(51) Int. Cl. C01B 17/02; B01J 19/00

(52) U.S. Cl. 423/578.1; 422/187

(57) ABSTRACT

Sulfur sought to be removed from deposits formed at a subterranean gas producing well is dissolved in a high boiling point relatively pure and low cost non-aqueous solvent. The dissolved sulfur is then removed from the solvent by lowering the temperature of the solution to precipitate the sulfur which is then separated and recovered as a relatively pure product. After additional processing the regenerated solvent is injected back down the well hole to dissolve additional sulfur and reutilized in successive cycles of the process. An amine or solubilizing agent may be added to the non-aqueous solvent, and an oxidizing agent may be provided during the process to oxidize polysulfides to sulfur.

### CROSS-REFERENCE TO RELATED APPLICATIONS

This application is a continuation in part of U.S. Ser. No. 11/207,566, filed Aug. 9, 2005, which claims priority from U.S. Provisional Patent Application Ser. No. 60/604,510 filed Aug. 26, 2004, the disclosures of which are herein incorporated by reference in their entirety.

### FIELD OF THE INVENTION

This invention relates generally to the production of natural gas from subterranean wells, and more specifically relates to the removal and recovery of sulfur that may be present when natural gas is produced from sour and other gas wells.

### BACKGROUND OF THE INVENTION

When natural gas is produced from gas wells and particularly from sour gas wells, solid sulfur or sulfur vapor is often generated if the gas is quite hot and accumulates or condenses on the well tubing itself and over time builds up thus reducing the gas flow or even plugging the well. This accumulated sulfur must be removed. One solution used in the past is to apply at the well a sulfur scavenger composition that dissolves the sulfur, and then discard the scavenger solution containing the sulfur. This solution, while sometimes perfectly effective, is also both economically wasteful and environmentally detrimental.

Kettner, U.S. Pat. No. 4,322,307 describes a process for treating a sour gas well in which an alkyl naphthalene base sulfur solvent is mixed with an oil carrier and circulated into the well and then recovered from the well mixed with the gas produced. After further processing, the sulfur is crystallized from the solvent under suitable cooling conditions and the solvent recovered for re-use. The sulfur from the separation is described as being delivered to a suitable sulfur disposal facility. The aforementioned carrier oil which is mixed with the solvent is needed so that a sufficient density differential can be achieved in order to readily accommodate separation of the solvent from entrained water contained in the production fluid. Kettner also describes other prior art processes and methodology that have been used in the past for removing sulfur by means of various solvents and the like.

The process of U.S. Pat. No. 4,322,307, while potentially useful is based on a solvent with a vapor pressure that is high enough to cause losses to the gas phase. In addition, the solvent used is not particularly economical, has many health and safety issues, and is not environmentally friendly.

U.S. Ser. No. 11/207,566, filed Aug. 9, 2005, describes a non-aqueous sulfur recovery technology that may be used for dissolving sulfur from a well bore thus preventing or inhibiting sulfur plugging the well. Sulfur to be removed from a gas producing well is dissolved in a high boiling point, relatively pure and low cost non-aqueous solvent solution. The sulfur is removed from the solution by lowering the temperature of the solution to precipitate the sulfur, with the sulfur then separated and used as a relatively pure product. The solution thereby regenerated, having a reduced sulfur concentration, may be injected back into the well hole to dissolve additional sulfur and then be re-utilized in subsequent cycles of the process.

This process uses a sulfur solvent that has a high solubility for elemental sulfur and a low vapor pressure, thereby reducing chemical consumption costs. The non-aqueous solvent may be, for instance, diphenyl ether, dibenzyl ether, a terphenyl or alkylated terphenyl, diphenylethane or alkylated diphenylethane, or mixtures thereof. The solvent may be injected downhole at relatively high pressures, for example 4000 psi. The solvent is normally heat stable at well over 260° F. and readily dissolves elemental sulfur deposits. The sulfur laden solvent may be transported with the gas to the wellhead where it is separated from the gas in a high pressure gas liquid separator. The solvent and any associated water is flashed and separated prior to regeneration and crystallization. The sulfur is crystallized and separated from the solvent and the regenerated solvent is reinjected into the well. Any vaporization losses are made up by using a solvent make up system.

### SUMMARY OF THE INVENTION

The present invention provides a method for removing and recovering sulfur present when natural gas is produced from a gas well by (a) dissolving sulfur in a non-aqueous solvent, (b) lowering the temperature of the solvent to precipitate the sulfur thereby removing the sulfur, and (c) separating the precipitated sulfur. The solvent may be, for instance, an alkylated naphthalene, an alkylated diphenylethane, a diphenyl ether, a dibenzyl ether, a terphenyl or an alkylated terphenyl, a diphenylethane or an alkylated diphenylethane, and mixtures thereof. The solvent may have a boiling point of above 200° C., 250° C., 275° C., 290° C., 300° C., 325° C. or even 350° C. at 1 atm. In especially preferred embodiments, the boiling point is above 290° C. at 1 atm. In many embodiments, the method further features re-circulating the solvent to the well after separating the precipitated sulfur. In preferred embodiments, the solvent is injected into the well at a pressure of 1 atm to 6,000 psi, preferably in the range of 2,000 to 6,000 psi. In some embodiments, an amine, or a solubilizing agent or both may be provided with the solvent. Further, in some embodiments an oxidizing agent is provided to oxidize polysulfides to sulfur.

In some embodiments, the method for removing and recovering sulfur present when natural gas is produced from a gas well features (a) providing a non-aqueous solvent; (b) providing an amine, or a solubilizing agent or both in the solvent or substantially concurrent with the solvent; (c) dissolving sulfur in the non-aqueous solvent; (d) lowering the temperature of the solvent to precipitate the sulfur thereby removing the sulfur; (e) optionally providing an oxidizing agent to oxidize polysulfides to sulfur; and (f) separating the precipitated sulfur. The oxidizing agent may be provided to a crystallizer. The solvent may be, for instance, an alkylated naphthalene, an alkylated diphenylethane, a diphenyl ether, a dibenzyl ether, a terphenyl or an alkylated terphenyl, a diphenylethane or an alkylated diphenylethane, and mixtures thereof. The solvent may have a boiling point of above 200° C., 250° C., 275° C., 290° C., 300° C., 325° C. or even 350° C. at 1 atm. In especially preferred embodiments, the boiling point is above 290° C. at 1 atm. In many embodiments, the method further features re-circulating the solvent to the well after separating the precipitated sulfur. In preferred embodiments, the solvent is injected into the well at a pressure of 1 atm to 6,000 psi, preferably in the range of 2,000 to 6,000 psi. In some embodiments, an amine or a solubilizing agent may be provided with the solvent.

Further, in some embodiments an oxidizing agent may be provided to oxidize polysulfides to sulfur.

In some embodiments, the method for removing and recovering sulfur present when natural gas is produced from a gas well features (a) injecting a sulfur dissolving solvent into a well bore, (b) separating gas from the solvent, (c) cooling the solvent; (d) removing solid sulfur from the solvent by filtration. The method may further feature reinjecting the lean solvent downhole to continue the process. The method may also further feature distilling the sulfur solvent. Such distilling may be performed in a distillation unit and may be performed to remove hydrocarbon diluents such as those absorbed from the gas stream. These hydrocarbon diluents may be collected and used or sold. The gas may be separated from the solvent according to step (b) in, for instance, a flash vessel by flashing. The solvent may be cooled according to step (c) in, for instance, a crystallizer. In some embodiments, the crystallizer is a Spouted Bed Crystallizer (SBC) while in other, preferred embodiments, the crystallizer is a Scraped Surface Crystallizer (SSC). The solvent may be cooled to a temperature of 60° C., 50° C., 40° C., 30° C., or even 20° C. or lower.

According to the present method, substantial elemental sulfur associated with gas is absorbed into the solvent thereby inhibiting formation of solid sulfur deposits that stick to the wall of well bores. In preferred embodiments, substantially all of the elemental sulfur associated with gas is absorbed into the solvent. In other embodiments, at least 99%, 95%, 90%, 80%, 75% or at least 50% of the elemental sulfur associated with gas is absorbed into the solvent. In preferred embodiments, the solvent contains at least 2, 5, 8, 10, 12, 13, 14, or 15 or more grams of sulfur dissolved per 100 grams of solvent, or 2, 5, 8, 10, 12, 13, 14, or 15 or more wt %, before cooling. In preferred embodiments, substantially no sulfur is lost to the gas when the gas is separated from the solvent. In other embodiments, no more than 0.1%, 0.2%, 0.3%, 0.4%, 0.5%, 0.7%, 1.0%, or 2.0% of the sulfur is lost to the gas when the gas is separated from the solvent. In some embodiments, a distillation unit is provided. In such embodiments, hydrocarbon diluents may be distilled and separated from the solvent and provided as a feedback for additional sub-processes or retained or sold as feedstock for other processes.

The present invention also features a system useful for removing sulfur downstream from sour wells, especially gas wells. The system features an injection pump, a gas/liquid separator, an oil/water separator, a flash vessel, a crystallizer, a sulfur filter system, and a distillation unit. In some embodiments, the crystallizer is a Scraped Surface Crystallizer. In other embodiments, it may be a Spouted Bed Crystallizer. In addition, the system may feature one or more additional tanks such as a slurry tank or a heated surge tank as well as means for transporting liquids and gases.

### BRIEF DESCRIPTION OF THE DRAWINGS

FIG. 1 is a diagrammatic illustration of a system for well head sulfur removal operating in accordance with the present invention.

FIG. 2 is a second diagrammatic illustration of a system for well head sulfur removal operating in accordance with the present invention.

FIG. 3 is a diagrammatic illustration of a system for well head sulfur removal where an amine or a solubilizing agent is added to the process. The amine or solubilizing agent may be added directly to the nonaqueous solution to encourage additional solid sulfur removal by formation of polysulfides. In such an embodiment, polysulfides are preferably oxidized to sulfur.

FIG. 4 is a diagrammatic illustration of a system for well head sulfur removal operating in accordance with the present invention further depicting a vent or flare from the crystallizer.

FIG. 5 is a diagrammatic illustration of a system for well head sulfur removal operating in accordance with the present invention where a typical Spouted Bed Crystallizer (SBC) is replaced with a Scraped Surface Crystallizer (SSC).

FIG. 6. FIG. 6A depicts a sulfur crystal from a small re-circulating slurry, conventional crystallizer. FIG. 6B depicts a sulfur crystal from a large spouted bed crystallizer, (factor of 10 larger scale).

FIG. 7 is a diagrammatic illustration of a system for well head sulfur removal operating in accordance with the present invention where a typical Spouted Bed Crystallizer (SBC) is replaced with a Scraped Surface Crystallizer (SSC), and a distillation unit is provided for removal of hydrocarbon diluents from the sulfur solvent.

### DETAILED DESCRIPTION OF THE INVENTION

The present invention provides a method for removing sulfur from a well, such as a gas producing well. The method includes dissolving sulfur in a non-aqueous solvent, preferably a relatively high boiling point, relatively pure and relatively low cost non-aqueous solvent, and preferably relatively environmentally friendly. Preferably, the solvent is not mixed with a carrier oil. The method further features removing the sulfur from the solvent by lowering the temperature of the solution to precipitate the solvent, whereby the sulfur is separated and used as a relatively pure product. The method also features injecting the regenerated solution, preferably lower in sulfur concentration as a result of the previous steps, back down the well hole to dissolve additional sulfur.

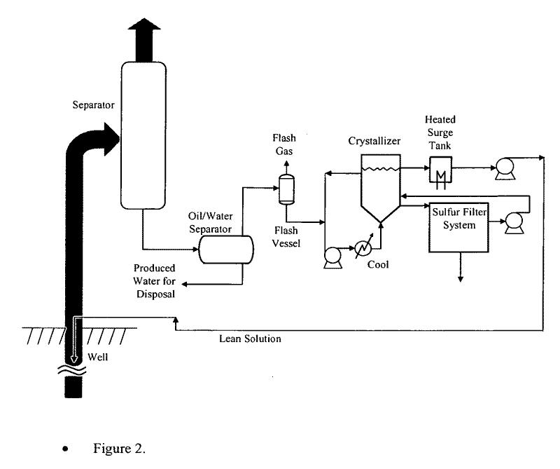

In some embodiments, an amine and/or a solubilizing agent is added to the process. The amine and/or solubilizing agent may be added directly to the nonaqueous solution to encourage additional solid sulfur removal by formation of polysulfides. In such embodiment, polysulfides are preferably oxidized to sulfur. A simplified drawing of the process is shown in FIG. 2.

The present invention uses a sulfur solvent having a relatively high solubility for elemental sulfur and a relatively low vapor pressure. These features reduce chemical consumption costs. The non-aqueous solvent is may be, for instance, a diphenyl ether, a dibenzyl ether, a terphenyl or alkylated terphenyl, a diphenylethane or an alkylated diphenylethane, and mixtures thereof. Preferably the solvent has a boiling point above 290° C. (at one atmosphere). In especially preferred embodiments, the solvent contains one or more diphenyl ethers. The solvent is injected downhole at a typical pressure in the range of atmospheric to 6,000 psi. Preferably, the solvent is not mixed with a carrier oil. Preferably, relatively high pressures in the range of 2,000 to 6,000 psi are used. The solvent is preferably heat stable at well over 260° F. Preferably, the solvent readily dissolves any elemental sulfur deposits. The solvent is then transported with the gas to a wellhead where it is separated from the gas, for instance, in a high pressure gas liquid separator. The solvent and any associated water may be flashed and separated prior to regeneration and crystallization. The sulfur may be crystallized and separated from the solvent and the regenerated solvent is reinjected into the well. Any vaporization losses may be made up by using a solvent make up system.

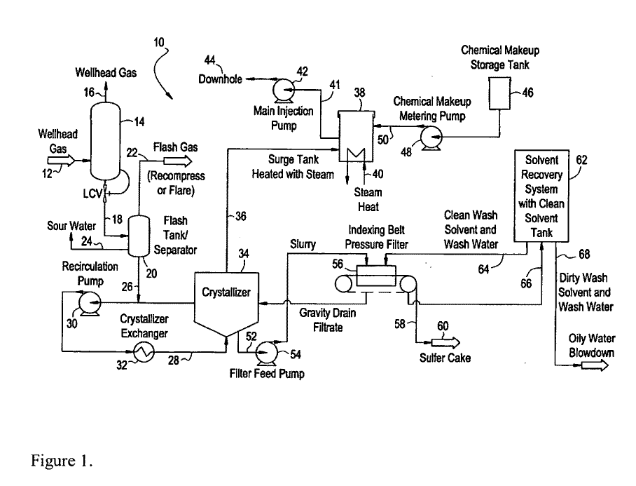

FIG. 1 depicts a system 10 in accordance with the present invention. Wellhead gas 12 is taken from a well at an underground subterranean formation and includes the gas which is usually (but not necessarily) sour along with the solvent which has been previously injected and may contain residual quantities of dissolved sulfur. The extracted gas and solvent are provided to a high pressure gas-liquid separator 14. The product gas is taken at 16 for its intended ultimate use. The solvent and dissolved sulfur proceeds from separator 14 via line 18 to a flash tank separator 20. The gas component is flashed there and exits at 22 where it can be recompressed or flared. Sour water is taken as one separated product at line 24. The solvent containing the dissolved sulfur proceeds via line 26 to a loop 28 which includes a re-circulation pump 30 and a heat exchanger 32. The cooled solution enters a crystallizer tank 34 where the sulfur is crystallized and the solvent then returned via line 36 to a surge tank 38 heated with a steam line 40. The solvent proceeds from surge tank 38 via line 41 to the main injection pump 42 and then downhole at 44. A chemical make up storage tank is provided at 46 which via a metering pump 48 provides make up solvent to tank 38 by line 50.

The sulfur (slurry) taken from crystallizer tank 34 proceeds via line 52 and a filter feedpump 54 which pumps the sulfur slurry to a pressure filter 56. Sulfur cake 60 is separated at that point and removed via 58 as relatively high purity sulfur. A solvent recovery system with clean solvent tank 62 provides clean wash solvent and wash water by line 64 to the pressure filter. Dirty wash solvent and wash water proceeds from the filter to tank 62 via line 66. Oily water blow down is taken at line 68 from the solvent tank and discarded or further treated for purification.

The sulfur crystallization process described herein may be used with suitable solvents in the processes disclosed in several patents including DeBerry et al., U.S. Pat. No. 6,416,729. The formation of large sulfur crystals by means of the present invention provides sulfur that is up to 99 percent pure and leaves the filter with only 2 to 5 percent water. In consequence the sulfur product is relatively dry and is of sufficient purity that it can be used in agricultural applications, blended into Claus sulfur (if available) or sent to a land fill as non-hazardous waste.

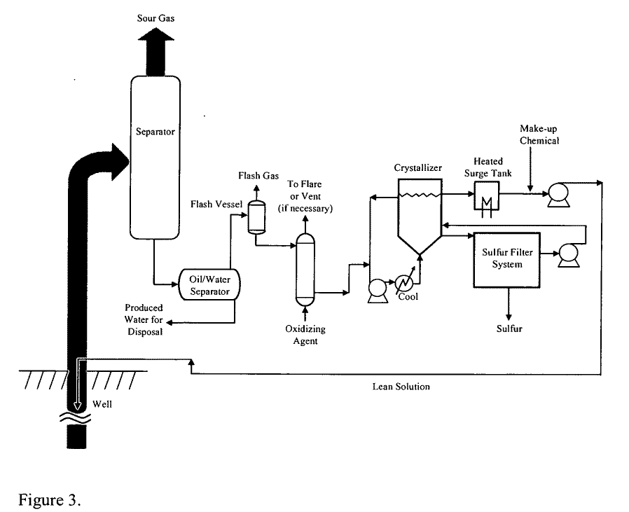

In some embodiments, an amine or a solubilizing agent or both is added to the process. The amine and/or solubilizing agent may be added directly to the nonaqueous solution to encourage additional solid sulfur removal by formation of polysulfides. In such embodiment, polysulfides are preferably oxidized to sulfur. A simplified drawing of the process is shown in FIG. 3. In some embodiments, for example, a solution of 0.01-0.3 M amine and 0.01-0.3 M solubilizing agent may be added to the sulfur solvent or injected down the well bore at substantially the same time as the sulfur solvent. The solution then interacts with the solid sulfur in the well bore to physically dissolve some sulfur due to high temperature and, in addition, some sulfur will react with H₂S and the amine to produce polysulfides. The reaction approximates:

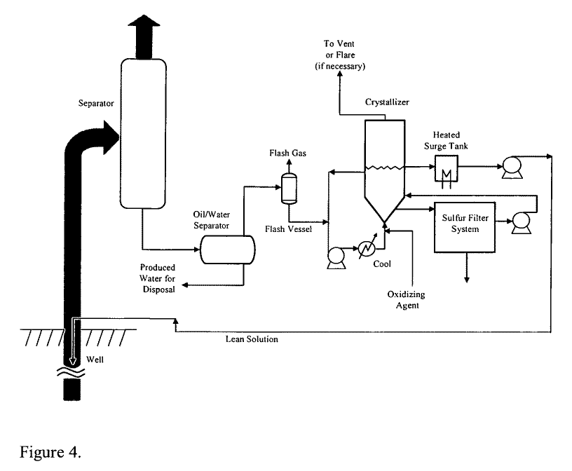

H₂S+S₈+B→HBHS₉

where B represents the amine. Other chain lengths of polysulfide other than 9 (as in (HBH)—S₉) are possible and likely. This mixture of solution containing sulfur and polysulfides then exits the well and passes through a separator where the gas is separated from the liquid. The liquid exits the gas/liquid separator and passes into an oil/water separator where the organic solution is separated from produced water. The water is disposed of or used elsewhere in the plant, the sulfur/polysulfide rich organic solution is kept heated to the well bore exit temperature or above (approximately 100-300° F.) and passes through a flash step where the pressure on the liquid is reduced to near atmospheric and any dissolved gases flash off. Some H₂S may be present in this flash gas stream. From the flash vessel, the liquid passes through an oxidizer where an oxidizing agent such as, for instance, sulfur dioxide (“SO₂”) or oxygen (“O₂”), is added to the rich solution to react with the polysulfides to form elemental sulfur. In some instances, as additional sulfur is formed from the polysulfide, it is possible that the amount of sulfur present at this point will then exceed the sulfur solubility of the solution, so that solid sulfur will form in the oxidizer. To prevent this, the oxidizing stream may be added directly to the crystallizer using a larger crystallizer vessel as shown in FIG. 4.

Within the crystallizer section and cooling loop, the temperature of the solution is reduced to reduce the sulfur solubility of the solution and precipitate solid sulfur. A spouted-bed crystallizer or scraped-surface crystallizer may be used. A sulfur filtration system removes solid sulfur from the crystallizer, and the sulfur exits the process. The now lean solution may be returned to the crystallizer. The lean solution overflows from the crystallizer and may be reheated to process temperatures for reinjection downhole.

Advantages of the Improved Downstream Sulfur Removal Methods

The current industry standard to alleviate gas wells from plugging by solid, elemental sulfur is to inject once-through chemical solvent that will dissolve the sulfur or prevent the sulfur from forming plugs within the gas well bore pipe. This once-through solvent, also called a scavenger, can dissolve approximately 6 percent by weight of sulfur from a well. For example, if 0.53 long ton of sulfur is produced in one well per day (0.53 LTPD of sulfur), the required solvent injection is approximately 8.5 long tons of solvent scavenger per day per gas well. The solvent that is currently most widely used in the industry has a cost in 2008 of about US $0.75 per pound. The daily cost of this sulfur scavenger in 2008 can easily be more than $10,000 for one gas well. In addition the used scavenger liquid must be disposed of or refined, and the scavenger operation has about a 9 LTPD spent scavenger stream that must be managed.

It is desirable to provide a process that re-uses the sulfur solvent, i.e., removes the sulfur from the solvent and then re-circulates that solvent back down the well. The process, downhole sulfur removal and recovery or DSR, provides many advantages. Compared to the scavenger process, the only solvent losses in the DSR process are due to vapour loss to gas streams and vent streams that exit the process plus any solvent degradation that may occur slowly over time. Accounting for vapour loss and degradation, the resulting daily chemical cost of such a DSR process is a small percentage of traditional processes when using alkylated naphthalene solvents. In addition, there is no waste stream other than the sulfur byproduct of 0.53 LTPD. That sulfur byproduct may be sold as a raw material for other processes such as fertilizer or sulfur dioxide production. The sulfur produced by gas treating in the oil and gas industry is typically re-used as a raw material for other process rather than discarded. In summary, the methods of the present invention provide significant advantages over conventional methods for sulphur removal for gas production. The methods of the present invention significantly reduce the cost of producing gas from wells that experience sulfur plugging, and produce a usable sulfur byproduct instead of a waste stream.

General Description of the Downstream Sulfur Removal Methods

The DSR methods of the present invention provide a non-aqueous sulfur recovery technology that can be used for dissolving sulfur from a well bore thus preventing sulfur plugging of the well. The sulfur to be removed from the gas producing well is dissolved in a high boiling point, non-aqueous solvent solution. The sulfur is removed from the solution by lowering the temperature of the solution to precipitate the sulfur, with the sulfur then being separated and used as an elemental sulfur product. The regenerated solution, with a lower sulfur concentration is injected back down the well to dissolve additional sulfur where it is re-utilized in subsequent cycles of the process. A simplified drawing of the DSR methods is provided in FIGS. 1 and 2.

Design Using a Scraped Surface Crystallizer

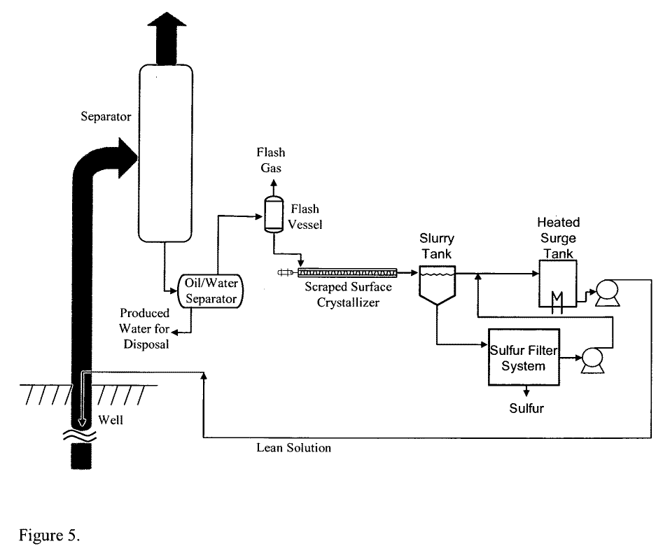

Some DSR methods such as those shown in FIGS. 1 and 2 make use of a Spouted Bed Crystallizer (SBC). The SBC is a large vessel, with a large solvent volume, a heavy weight and a large re-circulating liquid flow requirement. Other of the downstream sulfur removal methods, as shown in FIG. 5 replace a typical Spouted Bed Crystallizer (SBC) with a Scraped Surface Crystallizer (SSC) that may be used for the commercial process. Such a Scraped Surface Crystallizer is available from Armstrong Engineering Associates, Inc., West Chester, Pa.

An SSC offers substantial size, complexity, and cost advantages over a SBC. While the spouted bed crystallizer uses small delta T's (reductions in temperature), carefully maintained crystal suspensions and long residence times for large crystal growth, the SSC uses large delta T's, rapid crystal growth, and small residence times resulting in a large capacity per unit equipment size for the SSC. No re-circulation stream and associated piping and pumps are needed for an SSC unit. Inside, the SSC crystals form on the cold walls and are scraped off, producing slurry which is subsequently thickened and then sent to a sulfur filter.

Scraped surface crystallizers have been used in industry primarily for de-waxing operations in hydrocarbons and crystal development in aqueous liquors like sodium sulfate production. SSC technology has not been implemented previously for crystalline sulfur formation from hydrocarbon solvents. A typical SSC consists of multiple double pipe elements, generally with 6, 8, 10, or 12 inch nominal diameter inner pipes and larger diameter outer pipes. The annular space between the inner pipe and outer pipe is filled with cooling fluid. Each inner pipe contains a rotating scraper blade element which mixes the process fluid flowing through the inner pipe, and removes crystalline deposits which form on the inner pipe wall as cooling occurs.

In effect the SSC is a heat exchanger though it generally performs as a cooling crystallizer. Heat transfer occurs across the inner pipe wall, with cold fluid outside, and process fluid inside. As cooling occurs, crystals form on the inner pipe wall. The scraper blades rotate on the inner pipe wall and remove these deposits. The majority of the crystallization takes place in the bulk of the fluid, as opposed to the wall, thus allowing growth of easily separable crystals. A typical commercial sized installation consists of several double pipe elements, each with a length of 20 to 40 feet, connected in series. This provides a long thin flow path promoting a close approach to plug flow, which is important in many crystallizations processes.

Providing a Scraped Surface Crystallizer in the methods of the present invention provides the advantages of smaller equipment, which generally means less expensive installations, less floor space needed, less operator labor, and no duplication of instrumentation, pipe, etc.; better process control, less upsets of hazardous or expensive materials, and less peak utility demand; and modular design allowing for easy expansion with growth in demand; simple, self contained construction with minimum instrumentation and auxiliaries such as condensers, vacuum systems, etc. Further, the methods may be run for extended periods between hot washings whereas many shell and tube exchangers tend to plug up in minutes. Also, the methods may be run at much higher process fluid-coolant temperature differences than current shell and tube equipment without serious fouling or plugging. Additionally, the methods may be used over an extremely wide temperature range (−75° C. to +100° C.). Moreover, the methods may be used with high percentages of solids (as high as 65% solids as slurry) and can handle high viscosities (has been used with mother liquor viscosities of 10,000 cp or higher). Still further, the flow pattern in a once-through operation closely approaches plug flow so conversion from batch operation is easy. Virtually any desired time/temperature pattern is possible. Yet further, in small capacity cases, a scraped surface crystallizer will be less expensive. This is also true in cases where, for much larger installations, vacuum crystallization may seem most attractive.

The downstream sulfur removal methods of the present invention use a sulfur solvent that has a high solubility for elemental sulfur and a low vapor pressure, thereby reducing the chemical consumption cost. The non-aqueous solvent may be one or more of diphenyl ether, dibenzyl ether, terphenyls and alkylated terphenyls, diphenylethanes, 1-methylnaphthalene, 2-methylnaphthalene, dimethylnaphthalenes and alkylated diphenylethanes, and mixtures thereof. The solvent may be injected downhole at high pressures, for example 2000 psi, 3000 psi, 4000 psi, 5000 psi or more. The solvent may heat stable in excess of 200° F., 260° F., or even 300° F., 325° F. or 350° F. or more and may readily dissolve any elemental sulfur deposits. The sulfur laden solvent may be transported with the gas to the wellhead where it may be separated from the gas in a high pressure gas liquid separator. The solvent and any associated water may be flashed and separated prior to regeneration and crystallization. The sulfur may be crystallized and separated from the solvent and the regenerated solvent is reinjected into the well. Any vaporization losses may be made up by using a solvent make up system.

### EXAMPLE 1

### Sulfur Solubility

The sulfur solubility was determined along with some composition information and certain physical parameters for each solvent. Physical properties and composition of the sulfur solvents used in this work are listed in Table 1.

TABLE 1
Material Safety Data Sheet (MSDS) information for each example sulfur
solvent.

| | | | | | |
|---|---|---|---|---|---|
| Trade Name | Aromatic 200 | 1-Methyl- | Dimethylnaphthalenes, | Dowtherm Q | PXE |
| | (Alkylated | naphthalene | (mixture | (Alkylated | |
| | Naphthalenes) | | of Isomers) | Diphenylethanes) | |

Composition:

| | | | | |
|---|---|---|---|---|
| Name (CAS#) | Naphtha, | 1-Methyl- | Dimethylnaphthalene, | Phenyl-o- |
| | Heavy | naphthalene | mixture | xylylethane |
| | Aromatic | (90-12-0) | of isomers | (6196- |
| | (64742-94-5) | | (28804-88-8) | 95-8) |
| Concentration | 100% | >90% | >90% | >97% |

Individual Constituents:

| | | | | | |
|---|---|---|---|---|---|
| Name (CAS#) | 1-Methyl- | 1-Methyl- | Dimethylnaphthalene, | 1,1-Diphenyl- | Phenyl-o- |
| | naphthalene | naphthalene | mixture | ethane (000612- | xylylethane |
| | (90-12-0) | (90-12-0) | of isomers | 00-0 | (6196- |
| | | | (28804-88-8) | | 95-8) |
| Concentration | <12.5% | >90% | >90% | 50-66% | >97% |
| Name (CAS#) | 2-Methyl- | | | Ethylated | |
| | naphthalene | | | benzene, | |
| | (91-57-6) | | | byproducts from | |
| | | | | (068987-42-8) | |
| Concentration | <26.0% | | | 34-50% | |
| Name (CAS#) | Naphthalene | | | | |
| | (91-20-3) | | | | |
| Concentration | <14.0% | | | | |

Physical Properties:

| | | | | | |
|---|---|---|---|---|---|
| Boiling Point | 232-278° C. | 240-243° C. | n/a | 267° C. | 295° C. |
| Freezing Point | −19° C. | −22° C. | n/a | <−40° C. | Not |
| | | | | | established |
| Density | 0.996 kg/liter | 1.001 kg/ | 1.01 kg/liter | 0.97 kg/liter | 0.985 kg/ |
| | | liter | | | liter |

### Experimental Procedure

Each solvent or mixture of solvents was tested in a high pressure reactor to simulate the conditions that are expected down in a well bore and at a well head. In the high-pressure reactor vessel, excess sulfur and water were added to each solvent or mixture to be tested. Next, the cell was sealed, heated to 80° C. and pressurized to 3,500 psig with the gas composed of approximately 30% H₂S, 67% CH₄ and 3% CO₂ These conditions closely approximate typical wellhead conditions. A sample of the solvent was taken and the sulfur content measured to confirm the sulfur pickup by the solvent. A sample of the solvent was also flashed to atmospheric pressure to measure the volume of gas that is physically soluble in the solvent. This was used to determine the flash gas volume and composition that is expected when the liquid is flashed to atmospheric pressure for the sulfur crystallization/regeneration stage of the process. After the flash sample step, the liquid was cooled to 40° C. and a sample of the liquid at 40° C. was analyzed for sulfur content. This was done to determine the amount of sulfur that can be expected per unit volume of solution that can be recovered from the solution. For example, to determine the amount of sulfur in the regenerated solvent for re-injection down the well bore. In some cases additional cooled temperatures of 50° C. and 20° C. were measured to be able to generate a curve of sulfur solubility data at 20, 40, 50 and 80° C., rather than only testing the 2 temperatures of 80 and 40° C. The added information will help identify the optimum crystallizer operating temperature in the full scale DSR unit.

Each test was repeated multiple times to make sure that the tests were reproducible. The sulfur analysis was performed by burning the sample which would convert the sulfur present in the sample into SO₂, the SO₂ is then detected by infrared spectrometry. The gas composition was determined by added weight, and then verified by gas sample analysis using Gas Chromatography. The flash gas was also analyzed by Gas Chromatography.

In a downstream sulfur removal process, sulfur dissolving solvent is injected down into a well bore. The solvent comes into intimate contact with gas components (including elemental sulfur) and the well bore pipe. Any elemental sulfur associated with the gas is absorbed into the solvent thus preventing the formation of solid sulfur deposits that stick to the wall of the well bore and ultimately plug the well. The sulfur must remain dissolved in the sulfur solvent. For example, if alkylated naphthalenes is used as the sulfur solvent, using the results from Table 2, show that at down hole conditions of 80° C. and approximately 3000 psig, the alkylated naphthalenes solvent holds 13.9 grams of sulfur dissolved per 100 grams of alkylated naphthalenes solvent (and dissolved sulfur in the solvent), or 13.9 wt %. After the solvent and dissolved sulfur flow out of the well with the gas, the gas is first separated from the solvent, the solvent is flashed to near atmospheric pressure and the solvent is cooled to 40° C. The reduction in temperature is effected by a crystallizer (an SSC, in our case), and causes the crystallization of solid sulfur in the solvent. Alkylated naphthalenes will hold 7.7 wt % of dissolved sulfur at 40° C. The solid sulfur is removed from the solvent by filtration and the lean solvent is then reinjected downhole to continue the process. The difference between sulfur solubility at downhole conditions (13.9 wt % in this case) and the sulfur solubility at atmospheric pressure and 40° C. (7.7 wt % in this case) is approximately 6.2 wt %. Therefore, alkylated naphthalenes have about a 6.2 wt % sulfur solubility difference or “sulfur pickup”, as shown in Table 2. Applying this same approach to PXE as another solvent example, PXE has a negative sulfur pickup and therefore cannot be used as a sulfur solvent in this process. A solvent's sulfur solubility is affected by many variables and interactions at down hole conditions, high H₂S gas content, heavy hydrocarbons, water, etc., A summary of solvent sulfur pickup results is shown in Table 3.

TABLE 2
Sulfur Solubility Results for the Example Sulfur Solvents at Down Hole
Conditions (80° C.) and at Crystallization Conditions (50, 41, 40 or 20° C.).

| | Average | Sulfur | Sulfur | | | | |
|---|---|---|---|---|---|---|---|
| | Sulfur | Solubility | Solubility | Pressure | Gas Composition | | |
| | Solubility | Difference | Range | @ 80° C. | CH₄ | H₂S | CO₂ |
| Temp (° C.) | (wt %) | (wt %)* | (wt %) | (psig) | (%) | (%) | (%) |

Alkylated Naphthalenes

| | | | | | | | |
|---|---|---|---|---|---|---|---|
| 80 | 13.86 | n/a | 12.0-15.3 | 2990-3580 | 73-77 | 14-20 | 1.5-2.2 |
| 50 | 8.89 | 4.97 | 8.49-9.14 | | | | |
| 40 | 7.71 | 6.15 | 6.31-8.95 | | | | |
| 20 | 3.26 | 10.6 | 3.14-3.35 | | | | |

1-Methylnaphthalene

| | | | | | | | |
|---|---|---|---|---|---|---|---|
| 80 | 18.9 | n/a | n/a | n/a | 73.5 | 23.7 | 12.8 |
| 40 | 9.36 | 9.50 | n/a | | | | |

Dimethylnaphthalenes

| | | | | | | | |
|---|---|---|---|---|---|---|---|
| 80 | 21.2 | n/a | n/a | n/a | 71.9 | 24.7 | 3.4 |
| 40 | 7.19 | 14.0 | n/a | | | | |

Alkylated Diphenylethanes

| | | | | | | | |
|---|---|---|---|---|---|---|---|
| 80 | 8.76 | n/a | n/a | n/a | 67.1 | 25.4 | 7.4 |
| 40 | 5.26 | 3.50 | n/a | | | | |

PXE

| | | | | | | | |
|---|---|---|---|---|---|---|---|
| 80 | 3.09 | n/a | n/a | 1450 | 58.9 | 28.2 | 12.9 |
| 41 | 3.7 | −0.6 | n/a | | | | |

*Sulfur Solubility Difference is also termed sulfur pickup.

TABLE 3
Example Solvents Listed in order of Sulfur Pickup.

| | Sulfur |
|---|---|
| | Pickup |
| Solvent | (wt %) |
| Dimethylnaphthalenes | 14.0 |
| 1-Methylnaphthalene | 9.50 |
| Alkylated Naphthalenes | 6.15 |
| Alkylated Diphenylethanes | 3.50 |
| PXE | None |

In Table 4, two example cases are presented. In the first column of Table 4 alkylated diphenylethanes may be used as the sulfur solvent due to the low sulfur loading in the well (13 LTPD). However, for the second case, alkylated diphenylethanes cannot be used as the sulfur solvent, due to high sulfur loading (26.9 LTPD) and insufficient piping to allow for the large volume of liquid to be pumped into the well. Typically a gas well has two strings of tubing extending down to the bottom of the well. It is through these two tubes that the sulfur solvent can be injected. These tubes are typically ⅜″outer diameter and can allow only about a maximum of 7-9 gpm total per well in flow while also overcoming pumping into the very high pressure at the bottom of the well.

TABLE 4
Alkylated diphenylethanes used in high and low sulfur loading cases.

| | Low Sulfur | High Sulfur |
|---|---|---|
| Operating Parameter | Loading | Loading |
| Total gas flow (MMscfd) | 420 | 420 |
| Removed sulfur (LTPD) | 13 | 26.9 |
| Gas-liquid separator pressure (psig) | 928 | 928 |
| Gas-liquid separator temperature (° C.) | 74 | 74 |
| Flash vessel pressure (psig) | 70 | 70 |
| Flash vessel temperature (° C.) | 74 | 74 |
| Slurry tank pressure (psig) | 3 | 3 |
| Slurry tank temperature (° C.) | 40 | 40 |
| Injection Rate of Sulfur Solvent (gpm) | 91 | 189 |
| Injection Rate of Sulfur Solvent per | 6.5 | 13.5 |
| well, 14 wells (gpm) | | |

### EXAMPLE 2

### Solvent Volume Comparison with Scraped Surface Crystallizer substituted for Spouted Bed Crystallizer

The solution or solvent inventory volume for the process using a SSC compared to an SBC is shown in Table 5 for the indicated gas well operating conditions. The operating conditions are a model for 14 gas wells that produce a combined total gas volume flow of 420 MMscfd. These gas wells individually experience sulfur plugging during production, and the solvent is injected down the well bore of each of the 14 wells. The solvent flowing out of the 14 wells is combined into one gas/liquid stream and sent to a gas-liquid separator. The single liquid stream containing the sulfur and sulfur solvent is then passed to a single flash stage and crystallization/filtration stages. There are 14 individual gas wells but only 1 common treating facility to regenerate the sulfur solvent to be re-injected back into each of the 14 wells. The design parameters for the crystallizers are also included in Table 5.

TABLE 5
Process Volume for the Scraped Surface Crystallizer Compared to a
Conventional Spouted Bed Crystallizer

| | Spouted Bed | Scraped Surface |
|---|---|---|
| | Crystallizer | Crystallizer |
| Total gas flow (MMscfd) | 420 | 420 |
| Gas-liquid separator pressure | 928 | 928 |
| (psig) | | |
| Gas-liquid separator | 74 | 74 |
| temperature (° C.) | | |
| Crystallizer temperature (° C.) | 40 | 40 |
| Removed sulfur (LTPD) | 26.9 | 26.9 |
| Solvent flow (gpm) | 95 | 95 |
| Slurry tank operating volume | n/a | Negligible, only for |
| (ft³) | | surge during filter |
| | | wash cycles |
| Slurry re-circulation rate (gpm) | 627 | 0 |
| Design sulfur settling rate | 4 | not applicable |
| (gpm/ft²) | | |
| Cross-sectional area (ft²) | 156 | 0.785 |
| Diameter (ft) | 14.1 | 1 |
| Cone height (60° angle) | 12.2 | not applicable |
| Length of each SSC section (ft) | not applicable | 42 |
| Number of SSC sections | not applicable | 5 |
| required | | |
| Crystallizer operating volume | 10,648 | 1,234 |
| (gallons) | | |

The volume of the spouted bed crystallizer is 8.6 times the volume of the SSC for these design conditions. This increase in volume translates to an increase in cost of several tens of thousands of dollars at 2008 prices for the solvent used in the model (alkylated naphthalenes) and would be even more tens of thousands of dollars in 2008 prices when using alkylated diphenylethanes. The increase in volume directly translates into an increase in weight that must be supported by the overall structural steel; the increased liquid volume increases the mass by several tens of thousands of pounds.

The increase in volume also directly correlates to a larger equipment footprint for the SBC over the SCC. The SBC is a round vessel and by design a 15 foot diameter vessel is about the maximum diameter vessel than can be fabricated in a shop and shipped to a processing facility site. For this case, a 14.1 foot diameter SBC is required. If the application were larger, i.e., if +30 LTPD sulfur removal was required, then the crystallizer would have to be built on site and installed, which increases the cost and complexity of fabrication.

In addition, the spouted bed crystallizer requires a re-circulation pump for flow through the cooler to reduce temperature of the liquid whereas the SSC does not. Therefore, the pump, piping, instruments, installation of these items, and maintenance are removed from the process by using a SSC. The SSC reduces the complexity, capital and operating expense of the overall unit.

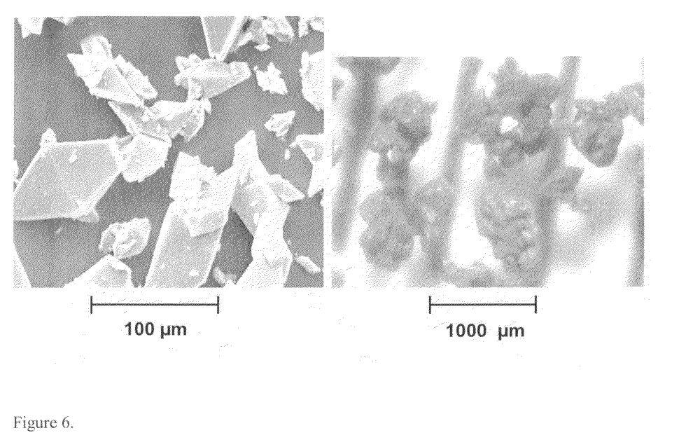

An unexpected advantage of using the SSC over the SBC is that the sulfur crystal size in the SSC is smaller than the crystal size when using a SBC. Smaller sulfur crystals provide significant advantages. In FIG. 6A sulfur crystals ranging from 10-150 microns in size are shown that are produced by a pilot plant utilizing a small re-circulating slurry loop crystallizer. FIG. 6B shows sulfur crystals produced by a larger, commercial size SBC, ranging from 50-500 microns in size. The crystals from the SBC are approximately five times larger than the sulfur crystal from the re-circulating slurry loop crystallizer. The results from the analysis of sulfurs sampled from each crystallizer are shown in Table 6. The results show that the larger crystal size contains a significant amount of hydrocarbons trapped in the sulfur particle as compared to the smaller crystal.

TABLE 6
Results from the composition analysis of the sulfur samples shown in
FIG. 6A (small-size crystals) and FIG. 6B (large-size crystals).

| | Small-size | Large-size | | | Regulatory |
|---|---|---|---|---|---|
| Constituent | Crystals | Crystals | Units | Method | Requirements |
| Cyanides | <0.5 | <0.5 | ppm | SW-9012 | |
| pH | 3.8 | 6.26 | pH | SW-9040 | 2-12.5 |
| | | | units | | allowed |
| Reactive | <50 | <20 | ppm | SW- | |
| sulfide | | | | 7.3.4.2 | |
| Corrosivity | Non- | Non- | | SW-9040 | Determined |
| | corrosive | corrosive | | | by pH |
| Carbon | 0.62 | 6.7 | % | AAS | |
| Hydrogen | <0.5 | 0.69 | % | AAS | |
| Nitrogen | <0.5 | 0.15 | % | AAS | |
| Sulfur | 99.5 | 86.8 | % | AAS | |
| Ash Content | 0.02 | 0.05 | % | | |

| | Small- | | | | | |
|---|---|---|---|---|---|---|
| | size | Large-size | | | STLC^{(a)} | TTLC^{(b)} |
| Constituent | Crystals | Crystals | Units | Method | (mg/L) | (mg/kg) |
| Antimony | <5 | <5 | ppm | SW-6010 | 15 | 500 |
| Arsenic | <0.5 | <0.5 | ppm | SW-6010 | 5 | 500 |
| Barium | <0.5 | <0.5 | ppm | SW-6010 | 100 | 10,000 |
| Beryllium | <0.5 | <0.5 | ppm | SW-6010 | 0.75 | 75 |
| Cadmium | <0.5 | <0.5 | ppm | SW-6010 | 1 | 100 |
| Chromium | <0.5 | <0.5 | ppm | SW-6010 | 560 | 2500 |
| Cobalt | <2.5 | <2.5 | ppm | SW-6010 | 80 | 8000 |
| Copper | <0.5 | 1.0 | ppm | SW-6010 | 25 | 2500 |
| Lead | <2.5 | <2.5 | ppm | SW-6010 | 5 | 1000 |
| Mercury | <0.2 | <0.2 | ppm | SW-7471 | 0.2 | 20 |
| Molybdenum | <2.5 | <2.5 | ppm | SW-6010 | 350 | 3500 |
| Nickel | <2.5 | <2.5 | ppm | SW-6010 | 20 | 2000 |
| Selenium | <0.5 | <0.5 | ppm | SW-6010 | 1 | 100 |
| Silver | <1 | <1 | ppm | SW-6010 | 5 | 500 |
| Thallium | <5 | <5 | ppm | SW-6010 | 7 | 700 |
| Vanadium | <0.5 | <0.5 | ppm | SW-6010 | 24 | 2400 |
| Zinc | <2.5 | <2.5 | ppm | SW-6010 | 250 | 5000 |
| Pensky- | >180 | >200 | ° F. | SW-1010 | | |
| Martens | | | | | | |
| Flash Point | | | | | | |

| | Small-size | Large-size | | |
|---|---|---|---|---|
| Constituent | Crystals | Crystals | Units | Method |
| TPH^{(c)} Total | 515 | 34,000 | ppm | DOHS/LUFT Man. Method |
| | | | | Mod. EPA 8015/8260 |
| Benzene | 0.041 | 0.64 | ppm | DOHS/LUFT Man. Method |
| | | | | Mod. EPA 8015/8260 |
| Toluene | 0.054 | 15 | ppm | DOHS/LUFT Man. Method |
| | | | | Mod. EPA 8015/8260 |
| Ethyl | 0.3 | 7.3 | ppm | DOHS/LUFT Man. Method |
| benzene | | | | Mod. EPA 8015/8260 |
| Total | 0.29 | 53 | ppm | DOHS/LUFT Man. Method |
| xylenes | | | | Mod. EPA 8015/8260 |
| Gasoline | <1.0 | 180 | ppm | DOHS/LUFT Man. Method |
| range | | | | Mod. EPA 8015/8260 |
| organics | | | | |
| (C4-C12) | | | | |

| | Small-size | Large-size | | Regulatory |
|---|---|---|---|---|
| Constituent | Crystals | Crystals | Units | Requirements |
| Fathead | 0 | 20 | of 20 | Pass: LC50 > 750 |
| minnow | (Passed) | (Failed) | minnows, | mg/L (<40% dead in |
| screen | | | number dead | 750 mg/L |
| | | | at 750 mg/L | concentration) |
| | | | sample | |

^{(a)}STLC: Soluble Threshold Limit Concentration
^{(b)}TTLS: Total Threshold Limit Concentration
^{(c)}TPH: Total Petroleum Hydrocarbons

The results show that larger crystals trap significant amounts of hydrocarbons within the solid matrix and would be classified as a hazardous waste. The small crystal solids would be classified as a non-hazardous waste. A Scraped Surface Crystallizer is the preferred method of crystallization over the Spouted Bed Crystallizer due to its smaller size, lower liquid volume, ability to produce smaller sulfur crystals, and therefore eliminate the need for hazardous waste disposal of the sulfur product.

### EXAMPLE 3

### Process Model Examples Solvent Vapor Loss of Alkylated Naphthalenes and Alkylated Diphenylethanes

Using similar conditions at half the sulfur loading (13 LTPD) that were used to model the crystallizer comparison case above, alkylated naphthalenes and alkylated diphenylethanes were each modeled separately as the sulfur solvent for this particular application. The results of the model for the vapor losses for each solvent are shown in Table 7. The objective of the comparison is to determine the solvent losses to the gas streams at typical gas well production operating conditions.

TABLE 7
Solvent Vapor Loss Comparison

| | Alkylated | Alkylated |
|---|---|---|
| Operating Parameter | Naphthalenes | Diphenylethanes |
| Total gas flow (MMscfd) | 420 | 420 |
| Solvent flow (gpm) | 45 | 90 |
| Removed sulfur (LTPD) | 13 | 13 |
| Gas-liquid separator pressure (psig) | 928 | 928 |
| Gas-liquid separator temperature | 74 | 74 |
| (° C.) | | |
| Flash vessel pressure (psig) | 70 | 70 |
| Flash vessel temperature (° C.) | 74 | 74 |
| Slurry tank pressure (psig) | 3 | 3 |
| Slurry tank temperature (° C.) | 40 | 40 |

Vapor Loss Results

| | | |
|---|---|---|
| Gas-liquid separator outlet gas (lb/hr) | 300 | 15 |
| Flash gas and other tank vents (lb/hr) | 50 | 2.5 |
| Total loss (lb/hr) | 350 | 17.5 |
| Total loss (US$/year) | 2,299,500 | 275,940 |

Case where the gas exiting the gas-liquid separator is cooled to 40° C.
and both the flash gas and vent gas from other tanks are cooled to 40° C.;
this is done to recover the solvent from the respective gas streams and add
that recovered solvent back into the process, i.e., reduce the solvent vapor
loss. Only the indicated temperatures are different, otherwise the cases
below are the same as the ones above.

| | | |
|---|---|---|
| Gas-liquid separator outlet gas | 40 | 40 |
| temperature (° C.) | | |
| Flash gas outlet temperature (° C.) | 40 | 40 |

Vapor Loss Results for Special Case
(Where Outlet Gas Streams are Cooled for Solvent Recovery)

| | | |
|---|---|---|
| Gas-liquid separator outlet gas (lb/hr) | 0.003 | 0.000 |
| Flash gas and other tank vents (lb/hr) | 29 | 0.60 |
| Total loss (lb/hr) | 29 | 0.60 |
| Total loss (US$/year) | 190,530 | 9,461 |

For the special case in Table 7, where the outlet gases are cooled to approximately 40° C. to recovery the sulfur solvent from the gas, two outlet gas coolers are required: one for the gas-liquid separator outlet gas and one for the flash vessel/slurry tank outlet gases. Furthermore, the gas-liquid separator outlet gas cooler and solvent recovery tank are preferably made of stainless steel due to the nature of the sour gas passing through. The stainless steel preference significantly increases the cost. Therefore, where applicable, alkylated diphenylethanes are used as the sulfur solvent.

### EXAMPLE 4

### Absorption of Significant Amount of Heavy Hydrocarbons by Sulfur Solvent

### Use of Distillation Unit

As the downstream sulfur removal process of the present invention operates, over time the sulfur solvent may absorb heavier hydrocarbons from the gas stream, typically hydrocarbons greater than pentane, i.e., contains more than 5 carbon atoms, and aromatic compounds, e.g., BTEX (benzene, toluene, ethylbenzenes and xylenes). The amount of absorbed heavy hydrocarbons (or heavy hydrocarbon diluents) in the solvent may reach a steady state, i.e., the same amount that is absorbed from the high pressure gas stream in the well will be flashed out into the flash gas on the low pressure side of the process. One disadvantage of the accumulation of the heavy hydrocarbon diluents is that the required volume of sulfur solvent necessary to inject down into the well to dissolve sulfur may be increased. Another disadvantage is that the sulfur dissolving ability of the solvent may decrease due to the heavy hydrocarbon diluents, hence it may be necessary to remove them from the solvent.

Table 8 provides the results from using Aspen to model data results for two sulfur solvents, alkylated naphthalenes and alkylated diphenylethanes, where the gas contains heavy hydrocarbon diluents. The results show that under steady state conditions, where the sulfur solvent is re-circulated through the steps of sulfur crystallization/filtration and then re-injected down into the well, as per the simplified diagram of FIGS. 2-5 and 7, the accumulation of heavy hydrocarbon diluents results in a dilution of the sulfur solvent by approximately 100%. The sulfur solvent only comprises approximately 50% of the liquid injected down into the well bore. Therefore, the heavy hydrocarbons are removed to improve the integrity of the sulfur solvent, i.e., re-establish the sulfur solvent ability to dissolve solid sulfur. Both of these cases could operate at the indicated pure solvent flow rate of approximately 90 gpm; however, with the heavy hydrocarbon diluents of nearly 100% dilution of the solvent, that resulting volume of total solvent cannot be injected down the wells. The amount of sulfur dissolved for alkylated naphthalenes is 26.9 LTPD compared to 13.0 LTPD for alkylated diphenylethanes, hence alkylated naphthalenes may be a better sulfur solvent.

TABLE 8
Solvent Injection Rates as a Result of Heavy Hydrocarbon Diluents

| | Alkylated | Alkylated |
|---|---|---|
| Operating Parameter | Naphthalenes | Diphenylethanes |
| Total gas flow (MMscfd) | 420 | 420 |
| Total solvent injection flow (gpm) | 189 | 175 |
| Portion of total solvent flow that is | 94 | 90 |
| only pure sulfur solvent flow (gpm) | | |
| Percent dilution of sulfur solvent (%) | 101 | 95 |
| Removed sulfur (LTPD) | 26.9 | 13 |
| Gas-liquid separator pressure (psig) | 928 | 928 |
| Gas-liquid separator temperature | 74 | 74 |
| (° C.) | | |
| Flash vessel pressure (psig) | 70 | 70 |
| Flash vessel temperature (° C.) | 74 | 74 |
| Slurry tank pressure (psig) | 3 | 3 |
| Slurry tank temperature (° C.) | 40 | 40 |

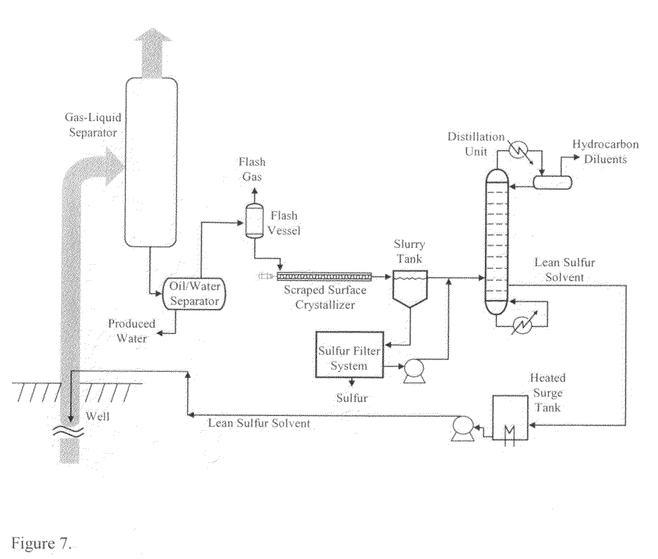

To remove the heavy hydrocarbon diluents from the re-circulating solvent, a distillation unit may be used. A distillation unit may be used to remove the heavy hydrocarbons from the solvent thus resulting in a solvent that is more pure to be re-injected down the well bore for removal of solid sulfur forming in the well bore. The simplified process diagram for this process is shown in FIG. 7, and the stream results are included in Table 8.

TABLE 9
Alkylated Naphthalenes Solvent Injection Rates with and without use of
a Distillation Unit

| | Without | |
|---|---|---|
| Operating Parameter | Distillation | With Distillation |
| Total gas flow (MMscfd) | 420 | 420 |
| Removed sulfur (LTPD) | 26.9 | 26.9 |
| Gas-liquid separator pressure (psig) | 928 | 928 |
| Gas-liquid separator temperature | 74 | 74 |
| (° C.) | | |
| Flash vessel pressure (psig) | 70 | 70 |
| Flash vessel temperature (° C.) | 74 | 74 |
| Slurry tank pressure (psig) | 3 | 3 |
| Slurry tank temperature (° C.) | 40 | 40 |

Solvent Injection Flow Rate Results

| | | |
|---|---|---|
| Total Diluted Solvent Injection Rate | 189 | 94 |
| Injection Rate of Pure Sulfur Solvent | 94 | 94 |

One unexpected benefit from using a distillation unit is that the hydrocarbon diluents may be condensed and used as feedstock for additional processes or sold as they are valuable. In effect, the inclusion of the distillation unit at this location, i.e., near the gas well head, allows for the capture of heavy hydrocarbons at this location, instead of being required in the downstream gas production facility. The main intent of installing a distillation unit in the DSR process is to remove the heavy hydrocarbons from the sulfur solvent and use that condensed liquid stream to wash the solid sulfur byproduct, therefore improve the quality of the sulfur solvent. The distillate used to wash the sulfur is also recycled back to the feed of the distillation unit, i.e., the wash solvent is recovered. The added benefit of the use of a distillation unit is that the heavy hydrocarbon stream produced has a significant value and can be used as a feedstock for other chemical processes. The distillate that is used for the sulfur wash cycle is re-cycled and not used, so there will be a net produced heavy hydrocarbon stream of significant value.

While the present invention has been set forth in terms of specific embodiments thereof, the disclosure is such that numerous variations are enabled to those skilled in the art. Accordingly, the invention is to be broadly construed and limited only by the scope and spirit of the claims now appended hereto.

1. A method for removing and recovering sulfur present when natural gas is produced from a gas well comprising:
(a) dissolving sulfur in a non-aqueous solvent;
(b) lowering the temperature of the solvent to precipitate the sulfur thereby removing the sulfur; and
(c) separating the precipitated sulfur.

2. A method according to claim 2 wherein the solvent is selected from the group consisting of an alkylated naphthalene and an alkylated diphenylethane, and mixtures thereof.

3. A method according to claim 1 wherein the solvent has a boiling point of above 290° C. at 1 atm.

4. A method according to claim 1 further comprising recirculating the solvent after step (c) to the well.

5. A method according to claim 1 wherein (b) lowering the temperature of the solvent to precipitate the sulfur thereby removing the sulfur is performed in a Scraped Surface Crystallizer (SSC).

6. A method according to claim 1, wherein the solvent is injected into the well at a pressure of 2,000 to 6,000 psi.

7. A method according to claim 1 further comprising distilling the solvent.

8. A method according to claim 1 further comprising providing an amine or a solubilizing agent with the solvent.

9. A method according to claim 1 further comprising providing an oxidizing agent to oxidize polysulfides to sulfur.

10. A method for removing and recovering sulfur present when natural gas is produced from a gas well comprising:
(a) providing a non-aqueous solvent;
(b) providing an amine or a solubilizing agent in the solvent or substantially concurrent with the solvent;
(c) dissolving sulfur in the non-aqueous solvent;
(d) lowering the temperature of the solvent to precipitate the sulfur thereby removing the sulfur;
(e) providing an oxidizing agent to oxidize polysulfides to sulfur; and
(f) separating the precipitated sulfur.

11. A method according to claim 10 wherein the solvent is selected from the group consisting of an alkylated naphthalene and an alkylated diphenylethane, and mixtures thereof;

12. A method according to claim 10 wherein the solvent has a boiling point of above 290° C. at 1 atm.

13. A method according to claim 10 further comprising recirculating the solvent after step (f) to the well.

14. A method according to claim 10 wherein (d) lowering the temperature of the solvent to precipitate the sulfur thereby removing the sulfur is performed in a Scraped Surface Crystallizer (SSC).

15. A method according to claim 10, wherein the solvent is injected into the well at a pressure of 2,000 to 6,000 psi.

16. A method according to claim 10 further comprising distilling the solvent.

17. A method according to claim 10 wherein the oxidizing agent is provided to a crystallizer.

18. A method for removing and recovering sulfur present when natural gas is produced from a gas well comprising:
(a) injecting a sulfur dissolving solvent into a well bore;
(b) separating gas from the solvent;
(c) cooling the solvent; and
(d) removing solid sulfur from the solvent by filtration.

19. A method according to claim 18 further comprising reinjecting the solvent downhole.

20. A method according to claim 18 further comprising distilling the sulfur solvent.

21. A method according to claim 18 wherein the gas is separated from the solvent according to step (b) in a flash vessel by flashing.

22. A method according to claim 18 wherein the solvent is cooled in a crystallizer.

23. A method according to claim 22 wherein the crystallizer is a Scraped Surface Crystallizer (SSC).

24. A method according to claim 18 wherein the solvent is cooled to a temperature of 40° C. or lower.

25. A method according to claim 18 wherein at least 95% of the elemental sulfur associated with the gas is absorbed into the solvent.

26. A method according to claim 18 wherein the solvent contains at least 5 or more grams of sulfur dissolved per 100 grams of solvent, or 5 or more wt % before cooling.

27. A method according to claim 18 wherein no more than 1% of the sulfur is lost to the gas when the gas is separated from the solvent.

28. A system useful for removing sulfur downstream from sour gas wells comprising an injection pump, a gas/liquid separator, an oil/water separator, a flash vessel, a crystallizer, a sulfur filter system, and a distillation unit.

29. A system according to claim 28 wherein the crystallizer is a Scraped Surface Crystallizer.
